(19) United States
(12) Patent Application Publication
(10) Pub. No.: US 2014/0047771 A1
(43) Pub. Date: Feb. 20, 2014

(54) DOUBLE-ACTION DOOR

(71) Applicant: Hsing-Hua KUAN, Taipei (TW)

(72) Inventor: Hsing-Hua KUAN, Taipei (TW)

(21) Appl. No.: 13/706,555

(22) Filed: Dec. 6, 2012

(30) Foreign Application Priority Data
Aug. 14, 2012 (TW) 101215655

(51) Int. Cl. E05D 7/02

(52) U.S. Cl. CPC E05D 7/02
USPC 49/382

(57) ABSTRACT

A double-action door based on two door frames and one door panel of a door-in-door architecture so arranged that the door panel is biasable relative to the inner door frame in a first direction, and biasable with the inner door frame relative to the outer door frame in a second direction reversed to the first direction.

### BACKGROUND OF THE INVENTION

1. Field of the Invention

The present invention relates to door technology and more particularly, to a double-action door having wide open angle and two-way opening characteristics.

2. Description of the Related Art

A door can be used as a normal-open partition (e.g., for easy access) or normal-close partition (e.g., for access control) in a public place of a building.

In time of emergency, an escapee normally will push a closed door panel intuitively instead of pulling it. Technically, providing two-way escape route and keeping a fire door closed are requisite tasks to ensure a high level of safety.

Single-action and double-action doors are commercially available. A single-action door can simply be opened in one particular direction. A double-action door can be opened in either of two reversed directions. However, due to the limitation of the turning angle of the hinges between the door frame and the door panel, the opening angle of the door panel of a double-action door cannot be widely opened, for example, through 180 degrees.

### SUMMARY OF THE INVENTION

The present invention has been accomplished under the circumstances in view. It is therefore the main object of the present invention to provide a double-action door, which provides a door-in-door structure with a small door in a large door, allowing the door panel to be opened in either of two reversed directions.

To overcome conventional technical problems, the invention provides a double-action door of a door-in-door structure defining a large door and a small door in the large door. Thus, the double-action door can be opened in either of two reversed directions, providing a two-way escape route and keeping in a normally closed condition for fire protection.

The double-action door of the invention eliminates the drawbacks of conventional double-action doors that provide a limited door panel turning angle and can simply allow the door panel to be opened in either “Push” or “Pull” manner, i.e., the double-action door allows the door panel to be opened in a large angle by a push action or a pull action.

To achieve the objects of the present invention, the double-action door is based on the architecture of two door frames and one door panel. This double-action door is a door-set structure comprising an outer door frame, an inner door frame hinged to the inside of the outer door frame and biasable relative to the outer door frame in one direction, and a door panel hinged to the inner door frame and biasable relative to the inner door frame in a reversed direction. Subject to the reversed arrangement of the hinges between the outer door frame and the inner door frame and the hinges between the inner door frame and the door panel, the double-action door can be opened in either of two reversed directions in a large angle, for example, 180 degrees. Therefore the double-action door is practical for use as an escape door or fire door.

Further, a two-way door closer is mounted in the inner door frame and coupled between the outer door frame and the door panel for buffering the closing movement of the door panel and for enabling the door panel to be opened in either of two reversed directions.

Further, two double-action doors can be symmetrically arranged together, forming a double-swing double-action combination door.

### BRIEF DESCRIPTION OF THE DRAWINGS

FIG. 1 is a schematic elevational view illustrating an operation status of a double-action door in accordance with a first embodiment of the present invention.

FIG. 2 is an elevational view of the double-action door in accordance with the first embodiment of the present invention.

FIG. 3 is a schematic applied view of the first embodiment of the present invention, illustrating the door panel and the inner door frame biased relative to the outer door frame from a close position toward an open position.

FIG. 4 corresponds to FIG. 3, illustrating the door panel and the inner door frame biased relative to the outer door frame from the close position to the open position through 180 degrees.

FIG. 5 corresponds to FIG. 5, illustrating the door panel and the inner door frame biased relative to the outer door frame in the second direction (I).

FIG. 6 corresponds to FIG. 5, illustrating the door panel and the inner door frame biased relative to the outer door frame in the second direction (II).

FIG. 7 corresponds to FIG. 5, illustrating the door panel and the inner door frame biased relative to the outer door frame in the second direction (III).

FIG. 8 is a schematic applied view of the first embodiment of the present invention, illustrating the door panel biased relative to the inner door frame and the outer door frame from a close position toward an open position.

FIG. 9 is a schematic perspective view of a double-action door in an open position in accordance with a second embodiment of the present invention.

FIG. 10 is a schematic drawing of the second embodiment of the present invention, illustrating the door panel biased relative to the inner door frame and the outer door frame in the second direction from the close position toward the open position.

FIG. 11 is a schematic drawing illustrating the operation of the two-way door closer in one direction in accordance with the second embodiment of the present invention.

FIG. 12 is a schematic drawing illustrating the operation of the two-way door closer in a reversed direction in accordance with the second embodiment of the present invention.

FIG. 13 is a schematic perspective view of a double-action door in accordance with a third embodiment of the present invention.

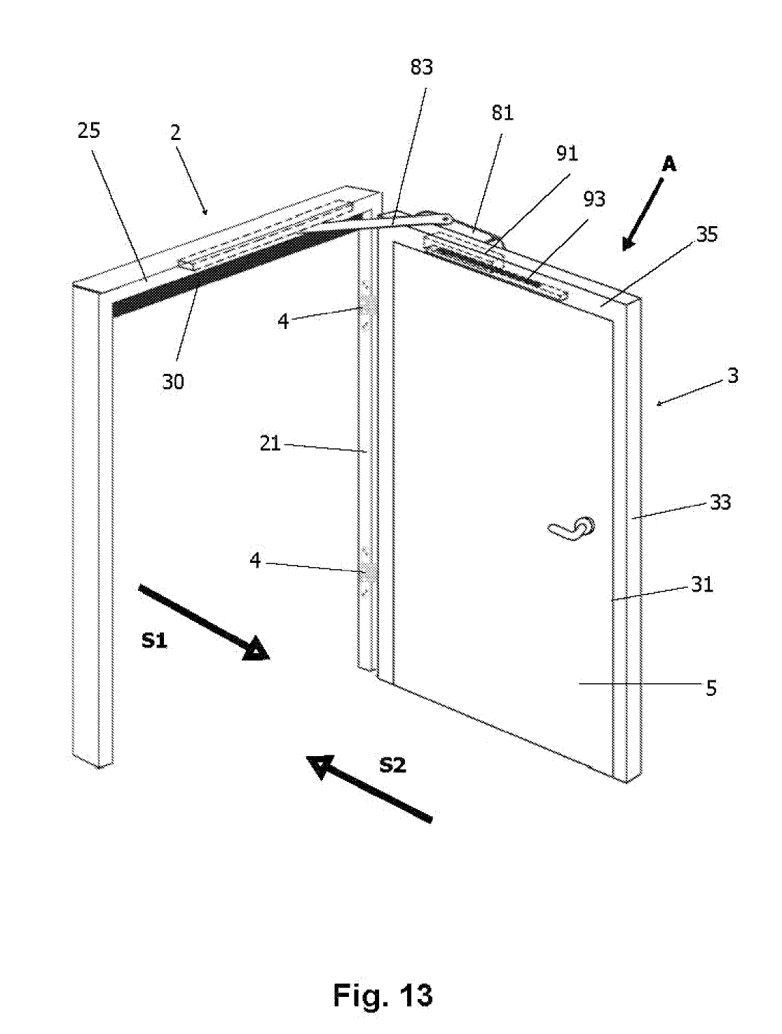

### DETAILED DESCRIPTION OF THE PREFERRED EMBODIMENT

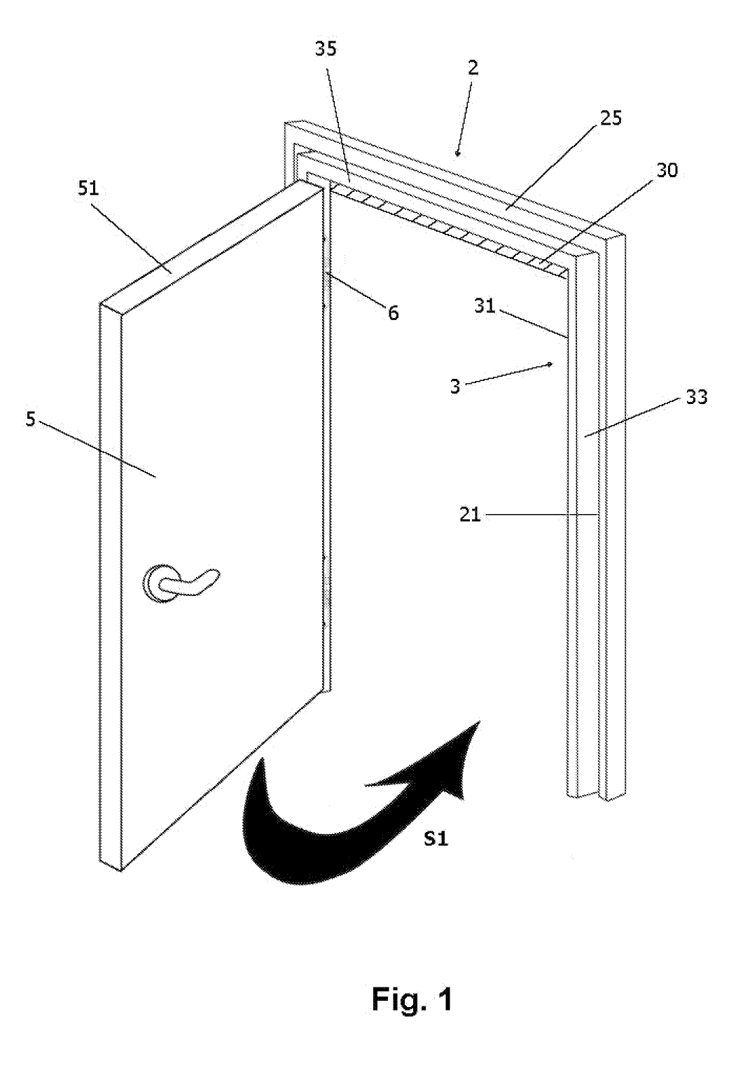

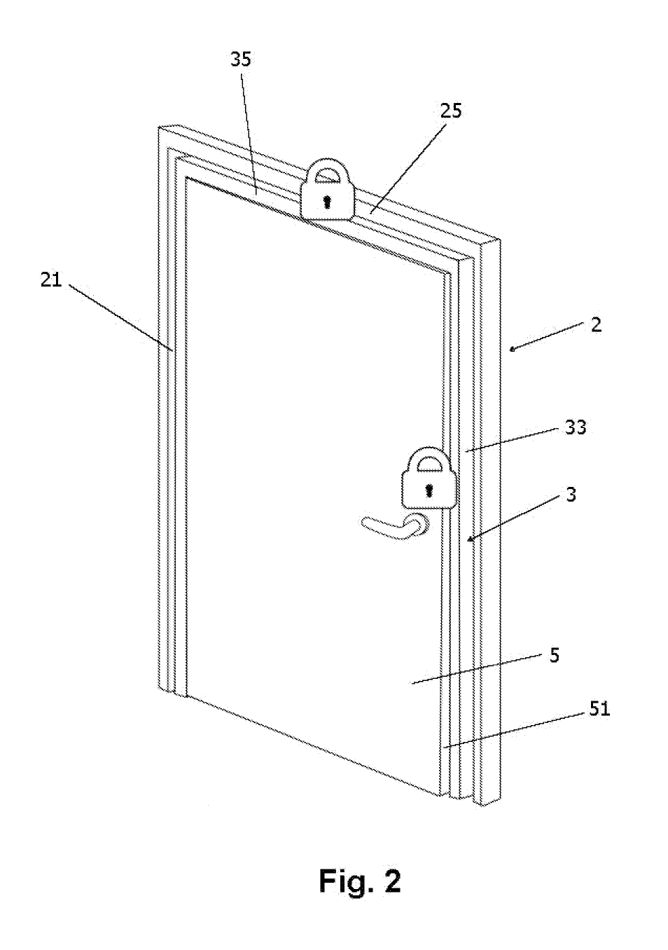

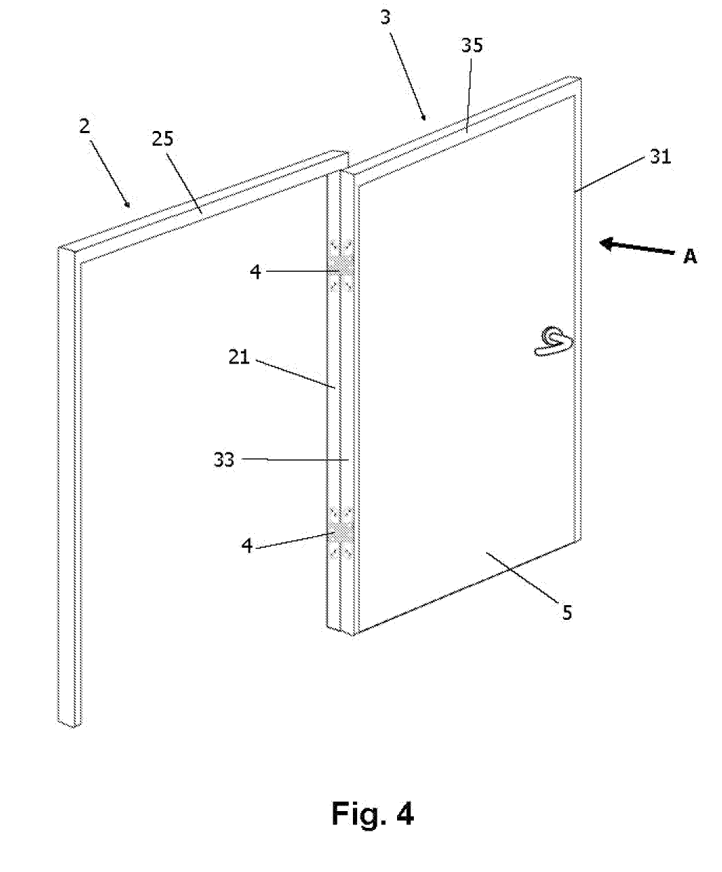

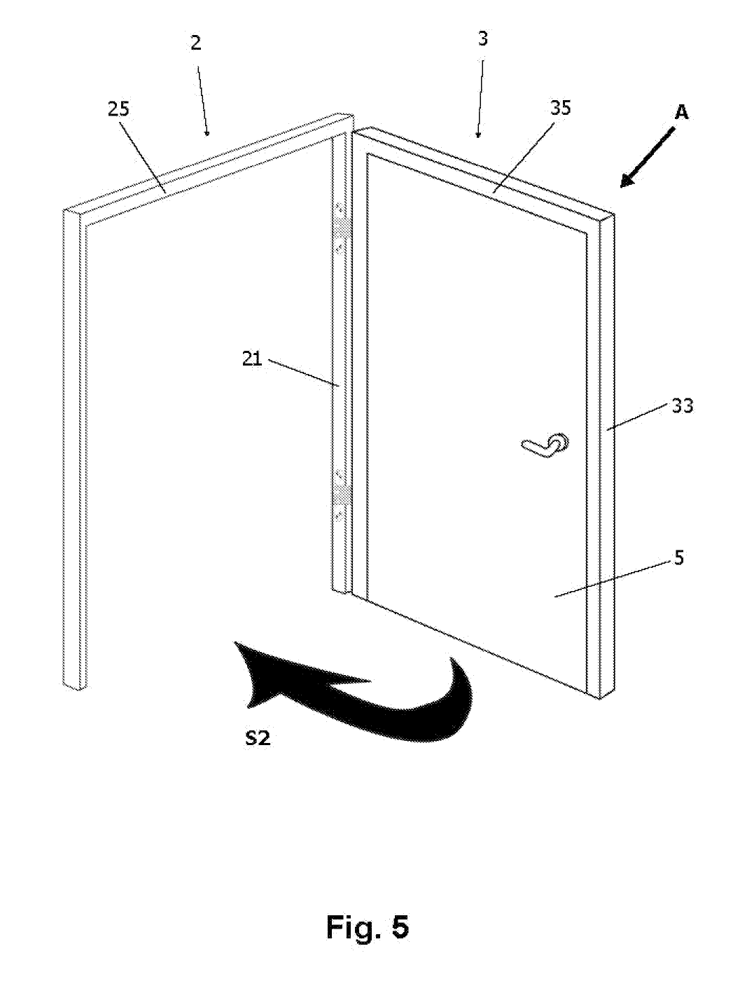

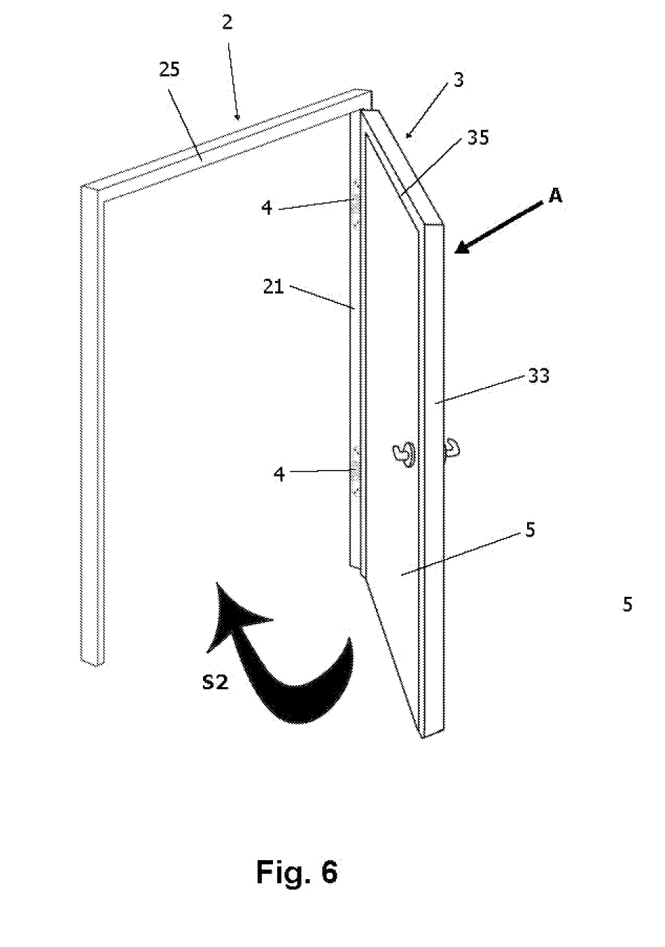

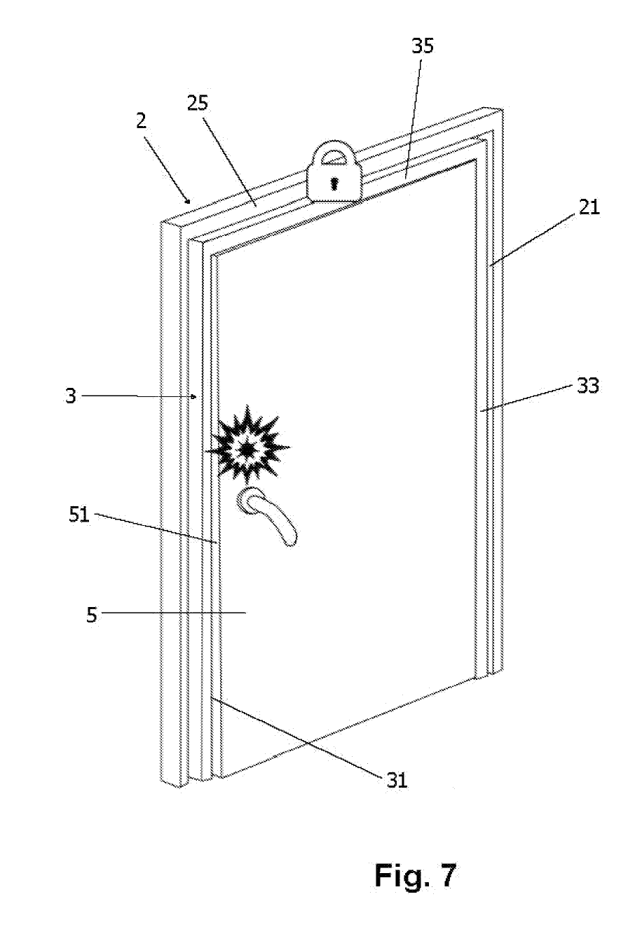

Referring to FIGS. 1-8, a double-action door in accordance with the present invention is shown. The double-action door comprises an outer door frame 2 defining an inner edge 21, an inner door frame 3 defining an inner edge 31 and an outer edge 33 opposite to the inner edge 31 and being smaller than the inner edge 21 of the outer door frame 2, at least one, for example, two first hinges 4 connected between the outer door frame 2 and the inner door frame 3 at different elevations for allowing the inner door frame 3 to be biased relative to the outer door frame 4 in a first direction S1 between a close position and an open position, a door panel 5 defining an outer edge 51 being smaller than the inner edge 31 of the inner door frame 3, at least one, for example, two second hinges 6 connected between the inner door frame 3 and the door panel 5 for allowing the door panel 5 to be biased relative to the inner door frame 3 in a second direction S2 reversed to the first direction S1 between a close position and an open position.

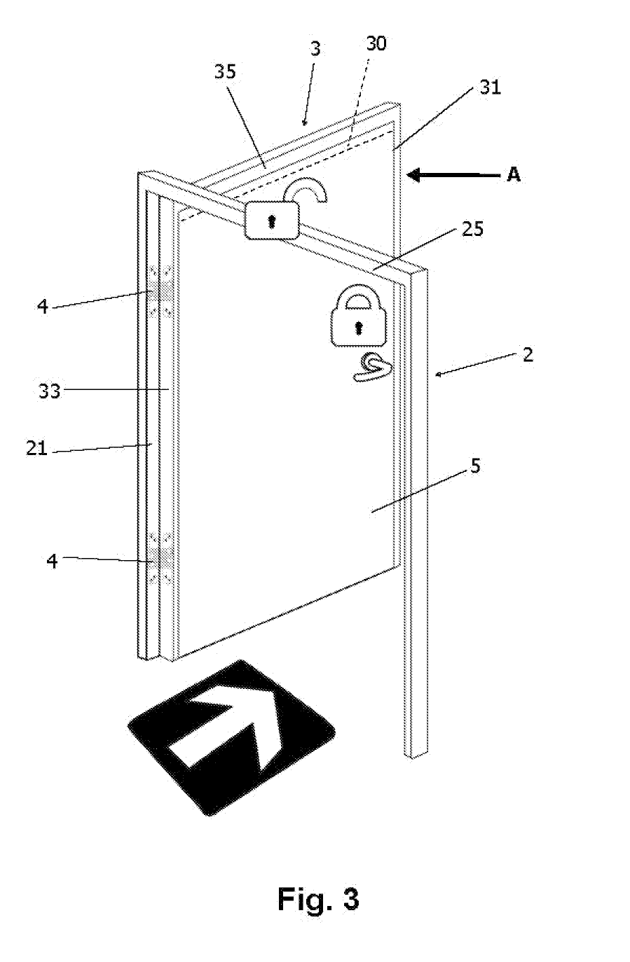

Referring to FIG. 3 again, the second hinges 6 prohibit the door panel 5 from being biased relative to the inner door frame 3 in the first direction S1, and allow the door panel 5 to be moved with the inner door frame 3 relative to the outer door frame 2 in the first direction S1 to open a large door A.

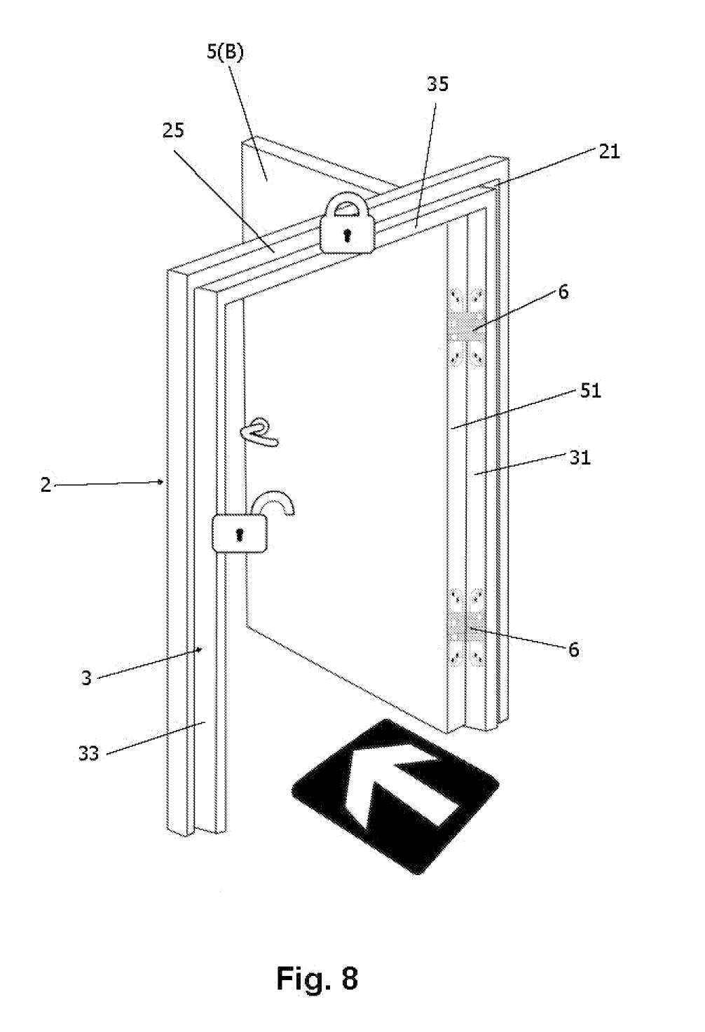

Referring to FIG. 8 again, the door panel 5 can be biased relative to the inner door frame 3 in the second direction S2 reversed to the first direction S1 to open a small door B.

Based on the aforesaid arrangement for allowing the large door A to be opened in the first direction S1 or the small door B to be opened in the second direction S2, the invention achieves a double action for outward or inward opening (leftward or rightward opening).

Referring to FIGS. 1 and 3 again, the inner door frame 3 further comprises a stop plate 30 covering a part, for example, the upper part of the inner edge 31 of the inner door frame 3 so that a corresponding part of the door panel 5 can be stopped against the stop plate 30 and moved with the inner door frame 3 in the first direction S1 steadily.

When compared to conventional door structures, the invention uses reversed hinges to couple the outer door frame 2, the inner door frame 3 and the door panel 5, forming a door-indoor architecture that is substantially a unique door-set structure of one frame with two door panels. This door-set structure defines a large door A, and a small door B in the large door A, wherein the inner door frame 3 and the door panel 5 constitute the large door A that can be turned relative to the outer door frame 2 between an open position and a close position in the first direction S1; the door panel 5 constitutes the small door B that can be turned relative to the inner door frame 3 between an open position and a close position in the second direction S2 reversed to the first direction S1. Thus, the double-action door of the present invention can be opened in a large angle in either of two reversed directions, achieving the functions of an emergency exit and a fire escape.

When compared to a conventional double-action door that limits the turning angle of the door panel, the invention allows the door panel to be biased through 180 degrees. When the double-action door of the present invention is used as an entrance door, interior door, access door or fire door in a building, it can work as a left-handed door as well as a right-handed door.

Further, the first hinges 4 or second hinge 6 are buffer hinges having gear buffer means, hydraulic buffer means, spring buffer means, pneumatic buffer means, friction buffer means, or any of their combinations mounted therein for enabling the large door or small door to be automatically returned to the close position after having been opened, or buffering the moving speed of the door panel to reduce noises.

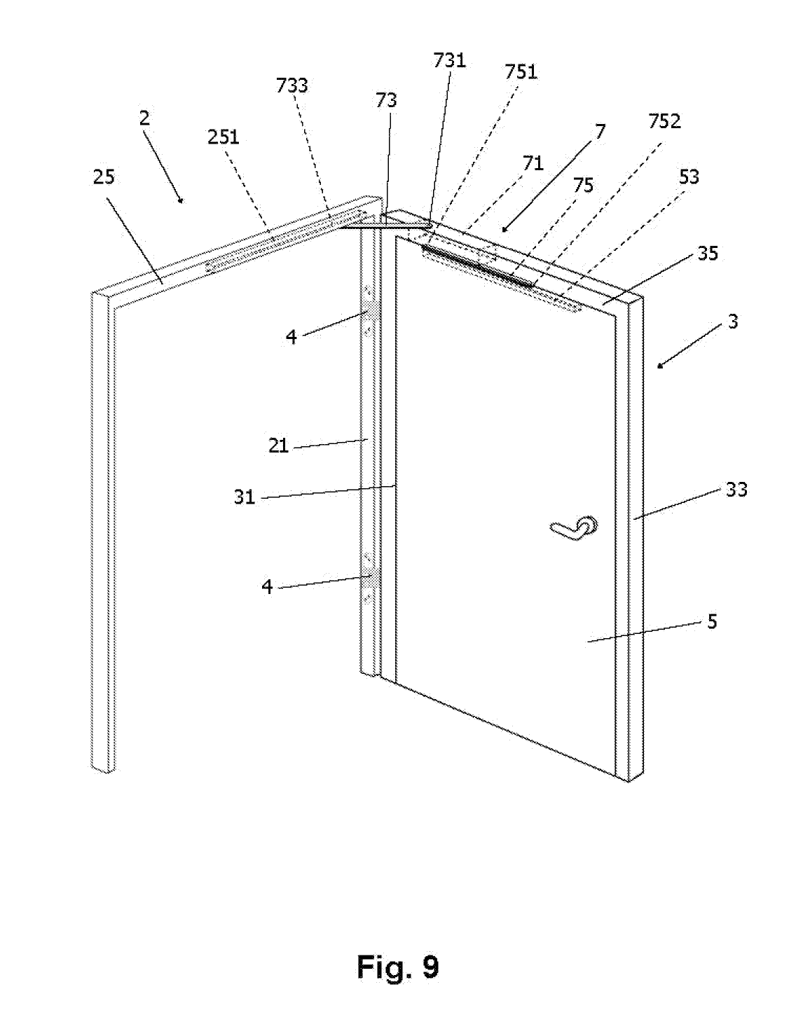

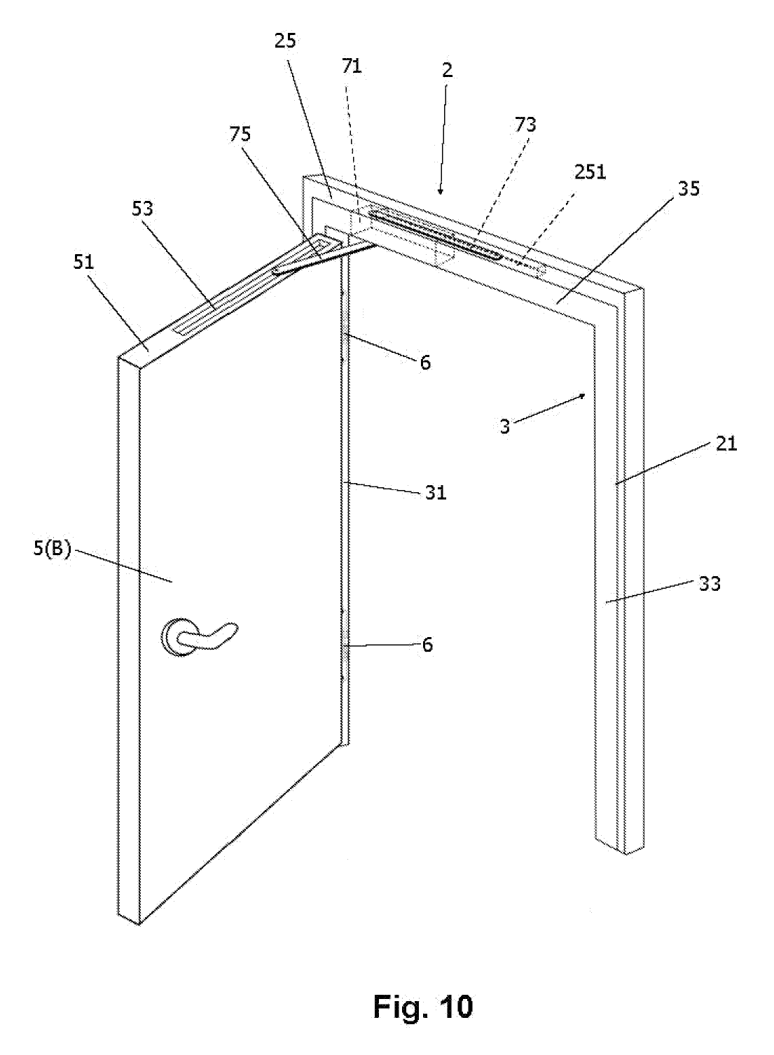

Referring to FIGS. 9 and 10, a double-acting door in accordance with a second embodiment of the present invention is shown. The double-action door of this second embodiment comprises an outer door frame 2 comprising an outer door frame inner edge 21 and a first top rail 25 at an upper side of the outer door frame inner edge 21, an inner door frame 3 comprising an inner door frame inner edge 31, an inner door frame outer edge 33 being smaller than the outer door frame inner edge 21 and a second top rail 35 at an upper side of the inner door frame inner edge 31, at least one, for example, two first hinges 4 connected between the outer door frame 2 and the inner door frame outer edge 33 at different elevations for enabling the inner door frame 3 to be turned relative to the outer door frame inner edge 21 in the first direction S1 between an open position and a close position, a door panel 5 comprising a door panel outer edge 51 smaller than the inner door frame inner edge 31, at least one, for example, two second hinges 6 connected between the inner door frame 3 and the door panel outer edge 51 for enabling the door panel 5 to be turned relative to the inner door frame inner edge 31 in a second direction S2 reversed to the first direction S1 between an open position and a close position to form a door-in-door structure, and a two-way door closer 7 comprising a casing 71 mounted in the second top rail 35, a first arm 73 coupled to one side of the casing 71 and turnable in the first direction and a second arm 75 coupled to an opposite side of the casing 71 and turnable in the second direction S2 reversed to the first direction S1. Further, the first arm 73 defines a first front end 731 coupled to one side of the casing 71 and turnable relative to the casing 71 in the first direction S1, and a first rear end 733 coupled to the first top rail 25. The second arm 75 defines a second front end 751 coupled to the opposite side of the casing 71 and turnable relative to the casing 71 in the second direction S2, and a second rear end 752 coupled to the door panel 5.

The first top rail 25 defines a first sliding groove 251. The first rear end 733 of the first arm 73 is slidably coupled to the first sliding groove 251. The door panel 5 defines a second sliding groove 53. The second rear end 752 of the second arm 75 is slidably coupled to the second sliding groove 53.

Thus, the inner door frame 3 and the door panel 5 constitute a large door that can be opened from the outer door frame 2 in the first direction S1; the door panel 5 can work as a small door and be biased relative to the inner door frame 3 in the second direction S2 reversed to the first direction S1 and away from the stop plate 30.

When compared to the aforesaid first embodiment, this second embodiment is characterized in the door closer that can buffer the speed. The first rear end 733 of the first arm 73 is movably coupled to the first top rail 25 to buffer the inner door frame 3 and the door panel 5 when they are moved in the first direction S1 between the open position and the close position. The second rear end 752 of the second arm 75 is movably coupled to the door panel 5 to buffer the door panel 5 when the door panel 5 is moved in the second direction S2 between the open position and the close position.

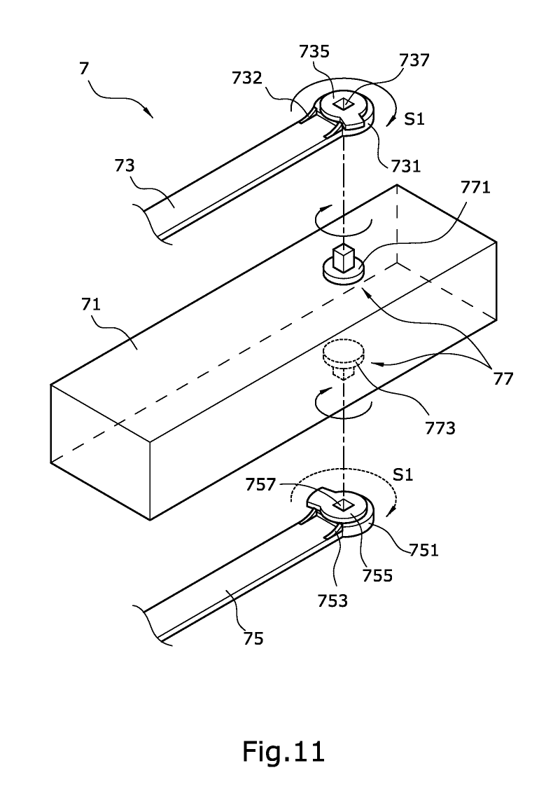

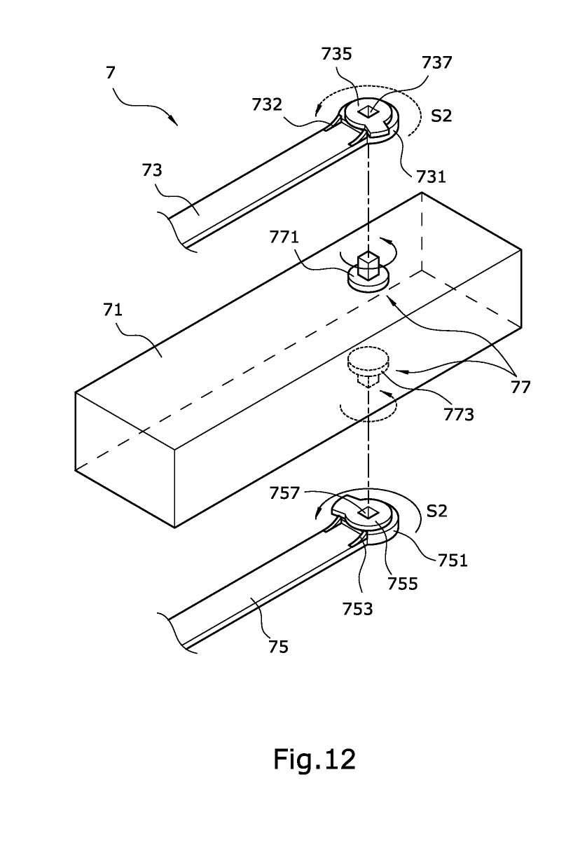

Referring to FIGS. 11 and 12, the casing 71 of the two-way door closer 7 comprises a shaft 77 defining opposing top end 771 and bottom end 773. The top end 771 extends out of one side of the casing 71. The bottom end 773 extends out of the opposite side of the casing 71.

The first arm 73 further comprises a first stop block 732 located at the first front end 731, a first cam 735 located at the first front end 731 adjacent to the first stop block 732, and a first shaft hole 737 cut through the first cam 735 and coupled to the top end 771 of the shaft 77. Thus, the first cam 735 can stop against the first stop block 732 to bias the inner door frame 3 and the door panel 5 in the first direction S1.

The second arm 75 further comprises a second stop block 753 located at the second front end 751, a second cam 755 located at the second front end 751 adjacent to the second stop block 753, and a second shaft hole 757 cut through the second cam 755 and coupled to the bottom end 773 of the shaft 77. Thus, the second cam 755 can stop against the second stop block 753 to bias the door panel 5 in the second direction S2. Referring to FIG. 11 again, the door panel 5 is stopped against the stop plate 30 at the inner door frame inner edge 31 to move the inner door frame 3 and the first cam 735 against the first stop block 737, biasing the inner door frame 3 and the door panel 5, i.e., the large door in the first direction S1.

Referring to FIG. 12 again, when the door panel 5 is pushed away from the stop plate 30 at the inner door frame inner edge 31, the second cam 755 is stopped against the second stop block 753 to bias the door panel 5, i.e., the small door in the second direction S2 reversed to the first direction S1.

Referring to 13, a double-action door in accordance with a third embodiment is shown. This third embodiment uses a first door closer 8 and a second door closer 9 to substitute for the aforesaid two-way door closer 7.

According to this third embodiment, the double-action door comprises an outer door frame 2 comprising an outer door frame inner edge 21 and a first top rail 25 at an upper side of the outer door frame inner edge 21, an inner door frame 3 comprising an inner door frame inner edge 31, an inner door frame outer edge 33 being smaller than the outer door frame inner edge 21 and a second top rail 35 at an upper side of the inner door frame outer edge 33, at least one, for example, two first hinges 4 connected between the outer door frame 2 and the inner door frame outer edge 33 at different elevations for enabling the inner door frame 3 to be biased relative to the outer door frame inner edge 21 in the first direction S1 between an open position and a close position, a door panel 5 comprising a door panel outer edge 51 being smaller than the inner door frame inner edge 31, and at least one, for example, two second hinges 6 connected between the inner door frame 3 and the door panel outer edge 51 at different elevations for enabling the door panel 5 to be biased relative to the inner door frame inner edge 31 in the second direction S2 between an open position and a close position.

The first door closer 8 comprises casing 81 fastened to the second top rail 35, and an arm 83 coupled to the outer door frame 2 and turnable relative to the outer door frame 2 in the first direction S1.

The second door closer 9 comprises a casing 91 fastened to the inside of the second top rail 35, and an arm 93 coupled to the door panel 5 and turnable relative to the door panel 5 in the second direction S2. The first top rail 25 defines a first sliding groove 251. The first arm 73 defines a first rear end 733 slidably coupled to the first sliding groove 251. The door panel 5 defines a second sliding groove 351 at a top side thereof. The second arm 75 defines a second rear end 752 slidably coupled to the second sliding groove 351. By means of the first door closer 8 and the second door closer 9, this third embodiment achieves the same effects as the aforesaid second embodiments.

Although a particular embodiment of the invention has been described in detail for purposes of illustration, various modifications and enhancements may be made without departing from the spirit and scope of the invention. Accordingly, the invention is not to be limited except as by the appended claims.

1. A double-action door, comprising:
an outer door frame defining an outer door frame inner edge;
an inner door frame defining an inner door frame inner edge;
at least one first hinge connected between said outer door frame and said inner door frame for enabling said inner door frame to be turned relative to said outer door frame inner edge between an open position and a close position in a first direction;
a door panel defining a door panel outer edge, said door panel outer edge being smaller than said inner door frame inner edge; and
at least one second hinge connected between said inner door frame and said door panel for enabling said door panel to be turned relative to said inner door frame inner edge in a second direction reversed to said first direction between an open position and a close position.

2. The double-action door as claimed in claim 1, wherein said door panel is movable with said inner door frame in said first direction subject to the constraint of said at least one second hinge to prohibit said door panel from moving in said first direction, thereby forming a large door.

3. The double-action door as claimed in claim 1, wherein said door panel is movable relative to said inner door frame in said second direction reversed to said first direction, forming a small door.

4. The double-action door as claimed in claim 2, wherein said door panel is movable relative to said inner door frame in said second direction reversed to said first direction, forming a small door.

5. The double-action door as claimed in claim 1, wherein said at least one first hinge and said at least one second hinge are buffer hinges.

6. The double-action door as claimed in claim 1, wherein said inner door frame further comprises a stop plate located at and covered on a part of said inner door frame inner edge for stopping against said door panel.

7-15. (canceled)
